(19) United States
(12) Patent Application Publication
(10) Pub. No.: US 2006/0183018 A1
(43) Pub. Date: Aug. 17, 2006

(54) Method of forming freestanding thin chromium components for an electochemical converter

(76) Inventors: Alfred Ramirez, Tuscon, AZ (US); David Tsay, Needham, MA (US); Michael S Hsu, Lincoln, MA (US)

Correspondence Address: LAHIVE & COCKFIELD, 28 STATE STREET, BOSTON, MA, 02109, US

(21) Appl. No.: 10/524,805

(22) PCT Filed: Aug. 13, 2003
(86) PCT No.: PCT/US03/25517

§ 371 Date: Apr. 5, 2005

Related U.S. Application Data
(60) Provisional application No. 60/403,218, filed on Aug. 13, 2002.

(51) Int. Cl. B32B 15/04; C04B 35/645; H01M 2/14; H01M 2/16; C03B 29/00; B32B 38/04

(52) U.S. Cl. 429/129; 156/89.12; 156/89.16; 156/250; 156/256; 156/278; 264/650; 264/663; 429/142; 429/144; 429/247

(57) ABSTRACT

A method of fabricating a high density thin component which can be used in an electrochemical converter comprises tape casting a material to form a tape followed by hot pressing of the tape to provide additional densification of the material. A plurality of tapes may be laminated together prior to hot pressing to provide a thicker structure or a composite structure. The materials used to produce the component may include silicon carbide, SiC, high chromium alloys, chromium iron alloys, (Cr-5 wt % Fe-1 wt % Y2O3) and chromium magnesium alloys (Cr-5 wt % Ni-1 wt % MgO). The fabrication method produces a high density component, including the application in an electrochemical converter, having a thickness of less than about 0.03 inches.

### RELATED APPLICATIONS

The present invention claims priority to U.S. Provisional Patent Application Ser. No. 60/403,218, filed Aug. 13, 2002, the contents of which are herein incorporated by reference.

### FIELD OF THE INVENTION

The present invention relates to a method of fabricating a component of an electrochemical converter.

### BACKGROUND OF THE INVENTION

Electrochemical converters generally comprise a series of electrolyte units onto which electrodes are applied, and a series of interconnector units, disposed between the electrolyte units, to provide serial electrical connections. Each electrolyte unit is typically an ionic conductor having low ionic resistance, thereby allowing the transport of an ionic species from one electrode-electrolyte interface to the opposite electrode-electrolyte interface under the particular operating conditions of the converter.

Various electrolytes can be used in such electrochemical converters. For example, zirconia stabilized with such compounds as magnesia, calcia or yttria can satisfy these requirements when operating at an elevated temperature, e.g., about 1000° C. These electrolyte materials utilize oxygen ions to carry electrical current. Generally, the electrolyte does not conduct electrons which can cause a short-circuit of the converter. The interconnector unit, on the other hand, is typically a good electronic conductor. In operation, the interaction of the input reacting gas, electrode and electrolyte occur at the electrode-electrolyte interface, which requires that the electrodes be sufficiently porous to admit the reacting gas species to, and to permit exit of product gas species from the electrolyte surfaces.

The approach of forming electrochemical converters from electrolyte and interconnector components, and the bulk integration thereof were disclosed by the present inventor in U.S. Pat. No. 5,833,822, U.S. Pat. No. 5,747,185, U.S. Pat. No. 5,338,622, U.S. Pat. No. 4,496,445, U.S. Pat. No. 4,629,537, and U.S. Pat. No. 4,721,556, all of which are herein incorporated by reference. In particular, U.S. Pat. No. 5,833,822 describes an electrochemical converter assembly having one or more converter elements having a peripheral edge. The converter element includes a series of electrolyte plates having an oxidizer electrode material on one side and a fuel electrode material on the opposing side, and a series of interconnector plates, alternately stacked with the electrolyte plates, that provide electrical contact with the electrolyte plates. The interconnector plate or the electrolyte plate may have a textured pattern that forms reactant-flow passageways. These passageways selectively distribute the fuel and oxidizer reactants introduced to the columnar converter element. For example, the passageways distribute the fuel reactant over the fuel electrode side of the electrolyte plate, and the oxidant reactant over the oxidizer electrode side of the electrolyte plate. Alternatively, a spacer plate can be interposed between the electrolyte and interconnector plates to provide passageways through which the reactants can flow. The spacer plate can be either a corrugated or a perforated plate.

### SUMMARY OF THE INVENTION

The present invention provides an improved method for fabricating a component of an electrochemical converter. The process of the present invention includes forming a free standing thin plate by using a tape casting method to form thin green sheets, and then applying a hot press method to densify the sheet to a near zero porosity state: A plurality of tapes may be laminated together prior to hot pressing to provide a thicker structure or a composite structure comprising layers of different materials. The resulting component is ultra dense, thin, has high oxidation and corrosion resistance, high electrical and thermal conductivity, hydrogen reduction stability, and low thermal expansion to match with ceramic components also used in the electrochemical converter. The process of the present invention can be applied to silicon carbide SiC, high chromium alloys, chromium iron alloys (e.g., Cr-5 wt % Fe-1 wt % Y2O3), chromium magnesium alloys (e.g., Cr-5 wt % Ni-1 wt % MgO) and mixtures thereof.

### BRIEF DESCRIPTION OF THE FIGURES

FIG. 1 illustrates an electrochemical converter employing an interconnector plate formed by the teachings of the present invention.

FIG. 2 is a schematic flow chart diagram illustrating a method for forming a component of an electrochemical converter according to an illustrative embodiment of the invention.

### DETAILED DESCRIPTION OF THE INVENTION

The present invention provides an improved method of fabricating a component of an electrochemical converter. The present invention will be described below relative to an illustrative embodiment. Those skilled in the art will appreciate that the present invention may be implemented in a number of different applications and embodiments and is not specifically limited in its application to the particular embodiments depicted herein.

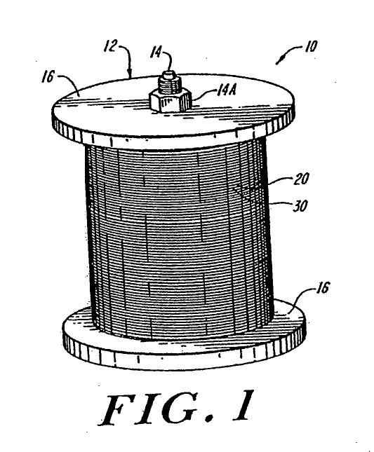

FIG. 1 shows an isometric view of an electrochemical converter 10 including one or more components manufactured according to the teachings of the present invention. The electrochemical converter 10 is shown consisting of alternating layers of an electrolyte plate 20 and an interconnector plate 30. Internal gas passages through the plates in the electrochemical converter provide conduits for the passage of fuel and oxidizer gases, e.g., input reactants, and permit the resultants to exit. Reactant flow passageways formed in the interconnector plates or the electrolyte plates facilitate the distribution and collection of these gases. A flow adjustment element (not shown), may be provided between each electrolyte plate and each interconnector plate to serve as a fluid-flow impedance between the plates by restricting the flow of input reactants through the reactant-flow passageways.

Gas seals and electrical contact between plates are obtained in the assembly by spring loading the interconnector plates against the surface of the electrolyte plates with or without seal materials. For example, the plates of the electrochemical converter 10 are held in compression by a spring loaded tie-rod assembly 12. The tie-rod assembly 12 includes a tie-rod member 14 seated within a central oxidizer manifold that includes an assembly nut 14A. A pair of endplates 16 mounted at either end of the electrochemical converter element 10, protects the interconnector and electrolyte plates from damage caused by these rigid structural components during compression of the plates. Compressing the interconnector plates 30 and the electrolyte plates 20 together maintains the electrical contact between the plates and provides gas sealing at appropriate places within the assembly.

High temperature electrochemical converters generally employ components that satisfy a number of demanding requirements, including the use of a thermally conductive metal of 10 btu/F-ft-hr and an electrically conductive metal of 10⁴ mho/cm, low thermal expansion ceramics of 5×10⁻⁶ in/in-F, a lightweight thin plate, for example, about 0.02 inch thickness, and a gas tight structure with no gas permeation. Moreover, electrochemical converters generally have an oxidation resistance up to about 1000° C.

In one aspect, zirconia, a refractory ceramic material, can be used as the electrolyte in the electrochemical converter due to its ability to conduct oxygen ions but not electrons at an elevated temperature of about 800-1000° C. The zirconia electrochemical converter offer higher efficiency than most other conventional or advanced energy conversion systems.

A zirconia electrochemical converter is assembled with thin plates of zirconia electrolyte alternately arranged with interconnector plates. The electrolyte plates are made of thin zirconia plates with electrode coatings. The interconnector plates are fabricated from corrosion-resistant, electrically conductive materials. To fabricate a zirconia electrochemical converter a freestanding electrolyte plate 20 with electrode coatings and a freestanding interconnector plate 30 are first fabricated. The plates are assembled by compression, with or without sealing material. Then, internal holes or manifolds and reactant-flow passageways can be formed in the plates to facilitate the passage of reactants and exhaust species.

The illustrated interconnector plates 30 provide multiple functions in the electrochemical converter. For example, the interconnector plates 30 provide low-loss electrical connections from cell-to-cell through a stack by contact with adjacent electrodes. The interconnector plates 30 also provide gas partitions to allow a repetitive series voltage connection of cells. The interconnector plates 30 also form effective thermal paths to conduct heat from the electrode surfaces to the outer edge of the plates, i.e., surfaces of the cell stack. The interconnector plates 30 may also form gaskets to prevent leakage of the reactants by the controlled yield of the material at operating temperature. Finally, the interconnector plates 30 also form stable structural members in the composite assembly encompassing the ceramic electrolyte plates and electrical conducting interconnector plates.

A wide variety of conductive materials can be used for the thin interconnector plates of this invention. Such materials should meet the following requirements: (1) high strength, as well as electrical and thermal conductivity; (2) good oxidation resistance up to the working temperature; (3) chemical compatibility and stability with the input reactants; and (4) manufacturing economy when formed into the textured plate configuration exemplified by reactant-flow passageways. The material also optionally and preferably exhibits a coefficient of thermal expansion that correlates closely with the ceramic electrolyte plates, including Zirconia electrolyte plates.

Traditional metallic plates are good electrical conductors in ambient environments. However, when subjected to high temperature and/or moist environment, the metallic conductors experience accelerated oxidation and corrosion degradations. One such circumstance exists in high temperature electrochemically converters. The fictional stacks of high temperature electrochemical converters require electrically conductive plates to act as serial electrical conductors and gas separation barriers for individual cells within the stack Such high temperature electrochemical converters today utilize super alloys or ceramic conductive plates to perform the described functions. Problems with the ceramic interconnectors include high cost, fragility, and low electrical conductivity. Drawbacks of the super alloy approach are multiple, including oxidation and corrosion problems that diminish its electrical conductivity and mechanical strength, and coefficient of thermal expansion (CTE) mismatch with the cell material that affects adversely the mechanical integrity of the stack.

Suitable materials for interconnector plate fabrication include silicon carbide (SiC), high chromium alloys, such as a chromium oxide mixture, chromium iron alloys (Cr-5 wt % Fe-1 wt % Y₂O₃) and chromium magnesium alloys (Cr-5 wt % Ni-1 wt % MgO). Chromium alloys are typically suitable for high temperature applications that employ ambient air of an oxidation environment One skilled in the art will recognize that the invention is not limited to these materials and that any suitable material may be used.

To facilitate radial heat transfer in the electrochemical converter stacks, electrolyte and interconnector plates of between about 5 centimeters and about 15 centimeters in diameter are appropriate. However, depending upon the application and design parameters, other sizes obvious to the ordinary skilled artisan will be obvious. Stacks of a relatively smaller diameter are suitable for systems requiring quick transient response, while stacks of a relatively larger diameter are appropriate for base-load power systems. A zirconia converter of modular design can be conveniently packaged as a small kW-level generator and also in a 10-25 kW module as a building block in scaled-up MW-level general applications. The distinctive features that make this electrochemical converter stack suitable for practical power applications are its high power density, ease of heat removal, structural ruggedness and low stress assembly.

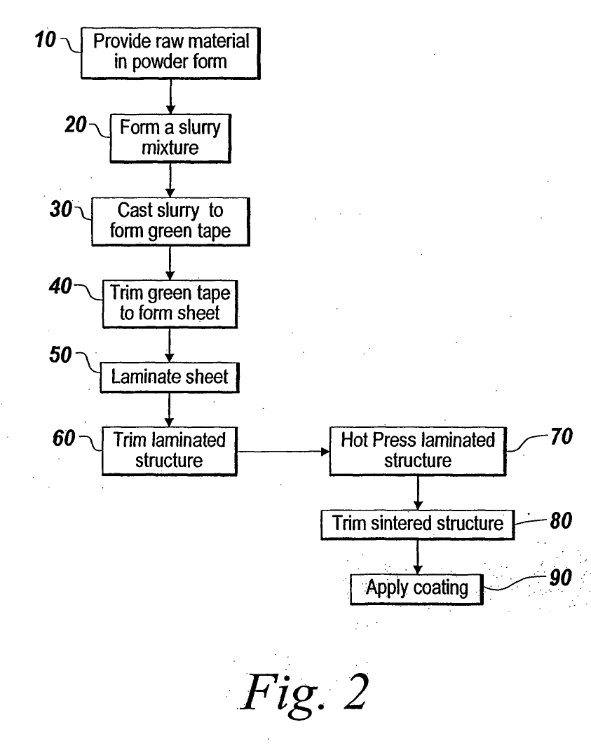

The present invention provides an improved fabrication method for producing a component of an electrochemical converter. FIG. 2 is a schematic flow chart diagram illustrating the steps involved in fabricating a component, such as a component of an electrochemical converter. The electrochemical converter components that can be made according to the method of the present invention include, but are not limited to, an interconnector plate and the contact surfaces of an interconnector plate. In an illustrative embodiment, the component is a lightweight thin plate having a thickness of less than about 0.03 inches and preferably about 0.02 inch and having a relatively gas tight structure with little or no gas permeation. According to one practice, the fabrication method may be used to produce a thin, chrome-based, composite electrically conductive plate offering relatively high oxidation and corrosion resistances, high electrical conductivity, and excellent CTE to match with ceramic electrochemical converter components, though one skilled in the art will recognize that the invention is not limited to a chrome-based plate.

As shown in FIG. 2, to produce a component, such as a plate of an electrochemical converter, and specifically an interconnector plate, a raw material of a selected composition in powder form is provided in step 10. In step 20, the component raw material is mixed with selected additives, such as solvents, plasticizers, binders and/or dispersants, to create a generally uniform slurry. Those of ordinary skill will be able to determine the appropriate types and amount of additives based upon the type of component to be made, the size and the application. The slurry may be produced in a milling or mixing machine, though the invention is not limited to these machines. In step 30, the slurry is then cast into a sheet form, such as a “green tape” or pre-form, using tape casting, roll compaction, extrusion or calendaring machines. For example, a tape casting machine produces a “green tape” by first pouring a slurry onto a flat surface, which may include a carrier film. A “doctor” blade is drawn over the slurry, or the slurry is drawn out beneath the doctor blade by the relative motion of the flat surface or carrier film, to produce a layer of tape with uniform thickness. The height of the blade, which is adjustable, controls the thickness of the tape. The slurry dries in air to produce the “green tape”, which is very flexible, due to the additives, and easy to handle. Each green tape produced in step 30 is then separately trimmed into one or more sheets in step 40. After formation of the sheets, a plurality of sheets can be optionally stacked and laminated into a multilayered laminate structures in step 50, to provide thickness control or to combine materials of different composition into a multilayered body. The laminate structure can comprise a composite structure having layers of different materials or a plurality of layers of the same material. The laminate structure may be mechanically, chemically or thermally machined or trimmed into predetermined configurations in step 60. Those of ordinary skill will readily recognize that the structure can be formed in any suitable shape.

After trimming, the laminate structure is hot pressed in step 70 by applying heat and pressure to form a high density, near zero porosity sintered structure. As used herein, the term “high density” refers to a material having a specific density of about 96% or greater, i.e., the material oecupiesat least 96% of the volume of the component, such that the total pore volume is less than about 4% of the total volume of the component. According to an illustrative embodiment, the step of hot pressing comprises sintering the laminate structure into a dense structure using a pressure-assisted furnace or kiln in an inert or reducing atmosphere. Suitable temperatures and pressure for performing hot-pressing are obvious to those of ordinary skill in the art, and are generally in the range of about 1300° C. and 1000 psi, respectively. After pressure sintering, the sintered structure may be mechanically, chemically, or thermally machined or trimmed to a desirable configuration in step 80. The trimmed sintered structure may be coated with other compounds, such as protective coatings, in step 90. According to one aspect, the coating may be applied using plasma spray, chemical vapor deposition, or physical vapor deposition equipment, though one skilled in the art will recognize that the invention is not limited to these coating techniques.

According to an alternate embodiment of the invention, the fabrication method includes a step of subjecting the laminated structure to a furnace sintering process before the hot press process in step 70.

According to an alternate embodiment, a raw material comprising a fine powder i.e., having a particle size on the nanometer scale, is used to form the component. In this embodiment, step 70 may alternatively comprise a pressure-free sintering step, which uses heat only to sinter the structure.

According to an illustrative embodiment, the component is an electrically conductive interconnector plate, though one skilled in the art will recognize that the illustrated fabrication method may be used to fabricate any suitable component, including that of an electrochemical converter, or any other plate. According to another aspect, the fabrication method of an illustrative embodiment of the invention produces a composite plate consisting of a high chromium core and a lanthanum chromite surface protection layer.

For example, according to an illustrative embodiment, the illustrated method produces an interconnector plate for an electrochemical converter that comprises a high chromium composite core and a lanthanum chromite surface protective sheet, though one skilled in the art will recognize that any suitable material may be used in the fabrication method of the present invention and any suitable component maybe produced. For example, to produce a chromium-lanthanum chromite composite plate, a sheet having a high chromium content, formed of a powder material that is preferably more than 95% chromium, is produced by tape casting, following steps 10-30 in FIG. 2. A lanthanum chromite sheet is also produced by tape casting, following steps 10-30 in FIG. 2. Then, the chromium sheet is placed on top of the lanthanum chromite sheet, and pressed into a laminate structure, in step 50. Alternatively, the high chromium sheet can be sintered without the lanthanum chromite layer. The high chromium composite core of the interconnector plate provides an impermeable separator for the electrochemical converter stack. The lanthanum chromite surface layer provides protection against the loss of chromium from vaporization in the form of Cr₂O₃ in the oxidizer side of the electrochemical devices.

The interconnector plate formed by the illustrative fabrication method may have textured surfaces, which oppose flat surfaces of adjacent electrolyte plates in the stacked electrochemical converter. Alternatively, the interconnector plate may have flat surfaces, which oppose textured surfaces of adjacent electrolyte plates in the stacked electrochemical converter.

The fabrication method of an illustrative embodiment of the present invention provides an ultra dense.(i.e., having a specific density of at least 96%), thin and cheaper component for an electrochemical converter. The fabrication method produces a component having high oxidation and corrosion resistance, high electrical and thermal conductivity, hydrogen reduction stability of up to 1000° C., and low thermal expansion to match with ceramic components.

It will thus be seen that the invention contains improvements over the prior art. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which as a matter of language, might be said to fall therebetween. For example, the fabrication method for dense thin plates of the present invention call also employ in any applications including the electrochemical devices such as molten carbonate, phosphoric acid, and proton exchange membrane converters.

1. A method of forming a component for an electrochemical converter, comprising the steps of:
casting a first slurry into a layer to form a first tape;
casting a second slurry into a layer to form a second tape;
laminating the first tape to the second tape to form a laminated structure; and
hot pressing the laminated structure using a combination of heat and pressure to form a sintered structure.

2. The method of claim 1, wherein the first slurry comprises a powder comprising chromium.

3. The method of claim 2, wherein the powder comprises at least 95% chromium.

4. The method of claim 1, wherein the second slurry comprises a powder comprising lanthanum chromite.

5. The method of claim 1, further comprising the step of trimming one of said first tape and said second tape.

6. The method of claim 1, fiber comprising the step of trimming the laminated structure.

7. The method of claim 1, further comprising the step of trimming the sintered structure.

8. The method of claim 1, further comprising the step of coating the sintered structure with a compound.

9. A component for an electrochemical converter comprising:
a first layer comprising a material having a composition that is at least 95% chromium; and
a second layer comprising lanthanum chromite laminated to the first layer, wherein the first layer and the second layer are hot pressed using a combination of heat and pressure to form the component.

10. The component of claim 9, wherein the component has a thickness of between about 0.01 and about 0.03 inches.

11. The component of claim 9, wherein one of the first and second layer forms a flat surface for opposing a textured surface of an adjacent electrolyte plate forming a flow passage in a stacked assembly that includes the interconnector plate.

12. The component of claim 9, wherein one of the first and second layer forms a textured surface for opposing a flat surface of an adjacent electrolyte plate forming a flow passages in a stacked assembly that includes the interconnector plate.

13. A method of forming a high density component, comprising the steps of:
casting a slurry material into a sheet; and
applying heat and pressure to sinter the sheet to form a sintered structure.

14. The method of claim 13, wherein the step of applying heat and pressure forms a sintered structure having a specific density of at least 96%.

15. The method of claim 13, further comprising the step of providing the material as raw material in a powder form.

16. The method of claim 13, further comprising the step of laminating the green sheet prior to the step of applying heat and pressure.

17. The method of claim 13, further comprising the step of sintering the green sheet prior to the step of applying heat and pressure.

18. The method of claim 13, wherein the material comprises one of: silicon carbide SiC, high chromium alloys, chromium iron alloys (Cr-5 wt % Fe-1 wt % Y₂O₃), chromium magnesium alloys (Cr-5 wt % Ni-1 wt % MgO) and mixtures thereof.

19. The method of claim 13, further comprising the step of coating the sintered structure with a compound.

20. The method of claim 19, wherein the step of coating comprises using plasma spray, chemical vapor deposition, or physical vapor deposition techniques.

21. A component for an electrochemical converter formed by the method of claim 13.

22. The component of claim 21, wherein the component has a thickness of between about 0.01 and about 0.03 inches.

23. An interconnector plate for an electrochemical converter formed by the method of claim 13.

24. The interconnector plate of claim 23, wherein material forming the interconnector plate has a composition that is at least 95% chromium.

25. An interconnector plate for an electrochemical converter formed by the method of claim 13, wherein the interconnector plate has flat surfaces which oppose textured surfaces of adjacent electrolyte plates forming flow passages in a stacked assembly that includes the interconnector plate.

26. An interconnector plate for an electrochemical converter formed by the method of claim 13, wherein the interconnector plate has textured surfaces which oppose flat surfaces of adjacent electrolyte plates forming flow passages in a stacked assembly that includes the interconnector plate.

27. A method of forming a high density thin plate, comprising the steps of:
casting a slurry material into a sheet; and
applying heat and pressure to sinter the sheet to a thickness of less than about 0.03 inches.
